(19) United States
(12) Patent Application Publication
(10) Pub. No.: US 2002/0146670 A1
(43) Pub. Date: Oct. 10, 2002

(54) Personal trainer scientific management system

(76) Inventors: Julien M. Selles, Milford, NH (US); Frank Stama, Amherst, NH (US)

Correspondence Address: HAYES SOLOWAY PC, 130 W. Cushing Street, Tucson, AZ, 85701, US

(21) Appl. No.: 10/068,262

(22) Filed: Feb. 5, 2002

Related U.S. Application Data
(60) Provisional application No. 60/266,101, filed on Feb. 5, 2001.

(51) Int. Cl. A63B 69/00; G09B 19/00

(52) U.S. Cl. 434/247

(57) ABSTRACT

This invention claims an automated physical training management system and method to be used preferably with hand held computer hardware, specifically as a tool for the professional fitness trainer. It allows a trainer to work using a small hand held piece of hardware which can be tied into other, larger and more complicated hardware to access a vast and often scattered assortment of necessary information and perform a plethora of analysis on recorded information to provide an optimal training regimen to clientele.

More specifically, this invention consists of an input device connected via a network to a central processing unit, which also includes storage capability.

### CROSS REFERENCE TO RELATED APPLICATIONS

This application claims the benefit of copending U.S. provisional patent application serial No. 60/266,101 filed Feb. 5, 2001, the teachings of which are incorporated herein by reference

### BACKGROUND OF THE INVENTION

This invention relates to an automated physical training management system to be used with hand held computer hardware, specifically as a tool for the professional fitness trainer.

Professional trainers in the past have designed and monitored workouts for a few clients at a single training facility. The professional trainer recorded the specifics of each workout, such as number of sets, reps, poundage used, duration and intensity of the workout, and cardiovascular performance, such as pace, distance, time, grade and heart rate. The trainer managed and evaluated client performance using paper charts, graphs and notebooks. If computerized tools were used, they were small hand held units, which did not tie to any larger, integrated system. Correlation of client information was done by hand and was complicated and time consuming. Reference to scientific standards was accomplished through the use of expensive texts, which frequently become outdated, or through time consuming compilation of scattered articles and reports.

Today's professional trainer must be able to do more to provide the best results for clients. They must be able to handle more clients at multiple facilities, and be able to adjust quickly and dependably to frequent changes in scheduling. Today's trainer must be able to measure and record strength, cardio-respiratory efficiency, and flexibility at a point in time, as well as track these levels over time, including identification of best and worst levels attained. Clients' nutritional programs must also be included as well as reactions to medications, consistency, duration and frequency of performance, injuries, and a wide variety of other factors. This information must be compiled by the professional into a total profile of a client, including snap shots of clients before and after different programs and tracking of progress. In addition, today's professional trainer must be able to offer additional services, such as morphing, integration of scientific “norms˜˜charts commonly accepted in the industry and recommended by the American College of Sports Medicine (“ACSM”).

There is presently no single tool that would record and store a wide range of accurate and immediately accessible information for all clientele, evaluate the clients' performance during training sessions, and aid the trainer in management of his or her schedule, while eliminating paperwork and wasted time.

The present invention is a tool for the professional fitness trainer which provides the integration of the needs discussed above. It allows a trainer to work using a small hand held piece of hardware which can be tied into other, larger and more complicated hardware via a network to access a vast and often scattered assortment of necessary information.

### SUMMARY OF THE INVENTION

This invention provides an automated physical training management system to be used preferably with hand held computer hardware, specifically as a tool for the professional fitness trainer. It allows a trainer to work using a small hand held piece of hardware which can be tied into other, larger and more complicated hardware to access a vast and often scattered assortment of necessary information and perform a plethora of analysis on recorded information to provide an optimal training regimen to clientele.

More specifically, this invention consists of an input device connected via a network to a central processing unit, which also includes storage capability.

### BRIEF DESCRIPTION OF THE DRAWINGS

FIG. 1 is a schematic drawing of the system of the present invention; and

FIG. 2 is a flow sheet illustrating some of the functions performed by the present invention.

### DETAILED DESCRIPTION OF THE PREFERRED EMBODIMENT

The preferred embodiment of the invention comprises an input device connected via a network to a central processing unit, which also includes storage capability wherein data inputted either into the portable input device(s) or the central processing unit may transfer to each other which relates to training regimens, health histories, measurements and the like for a specific client or series of clients.

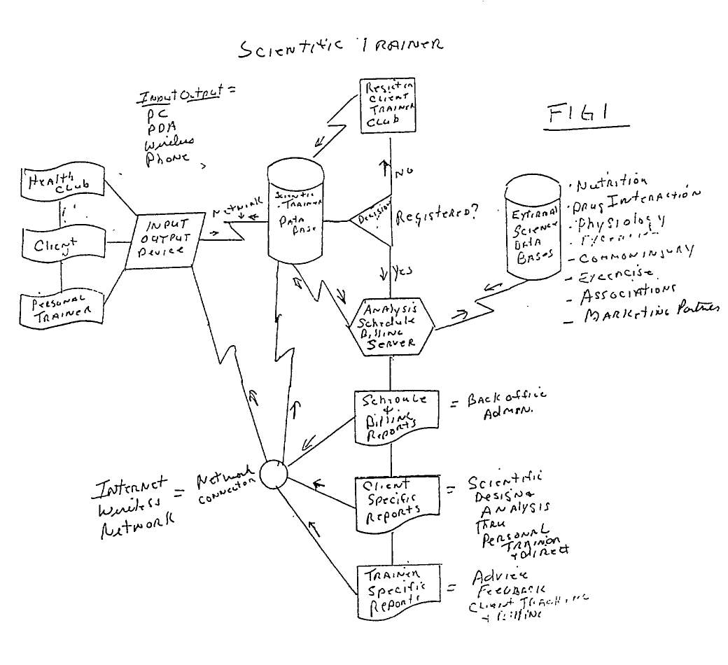

The system of the present invention, illustrated in FIG. 1, comprises at least one input device 2 for receiving input and output data or other information, which is preferably a hand held computer input device. The system may include multiple input devices 2a-n including, but not limited to, personal computers, PDAs capable of calendering and scheduling functions, telephones, and internet devices. These devices usually but are not required to includes a mechanism, such as a screen, for data display.

Optionally, other input devices for providing multiple inputs, such as an interactive piece of workout equipment, cameras, cardiac monitors, EKGs, EEGs, and the like for inputting data to enhance any output analysis or recommendations may be added.

The screen display 10 includes a complete schedule display with the ability to earmark client appointments, cancellations, vacation dates, special instructions, memos, etc. regarding each client. The user is able to change appointment times, switch clients, switch sessions, etc. as needed, as well as track changes made and obtained updated schedules. For example, daily and weekly totals of completed sessions, with names, dates, and times, are displayed.

The interface device 4 comprises a network system or a simple device-to-device mechanism, such as a serial port connection, internet systems, intranet systems, private nets, and phone or wireless systems.

The host computer hardware system 6 comprises a central processing unit. This central processing unit may be a web site. The central processing unit, in addition to the present invention, may include other tools 8. A few representative examples include, but are not limited to, resource management supply chain tools, logistics tools, process control tools, statistical tools, and the like.

The invention further comprises a data storage system 12. Stored data may include, but is not limited to, general client information, such as client identification number, client name, client address and phone, prices per session, number of sessions purchased, method of payment, number of sessions used, term of clientage, and more specific client information, such as age, height, weight, percentage of body fat, body mass index, doctors' prescriptions or orders and medication alerts, contraindications, injuries, blood pressure, cholesterol levels, experience level, client fitness goals, nutritional plan, workout session evaluation, and especially general approved scientific, medical and training databases. Forms such as signed consent forms may also be stored.

Potential users of the invention include, but are not limited to personal trainers, physical therapists, physical therapy assistants, strength coaches, nutritionists, physicians and other professionals in the fitness or medical community. Individual athletes or those involved in improving their own physical condition may also use the present invention.

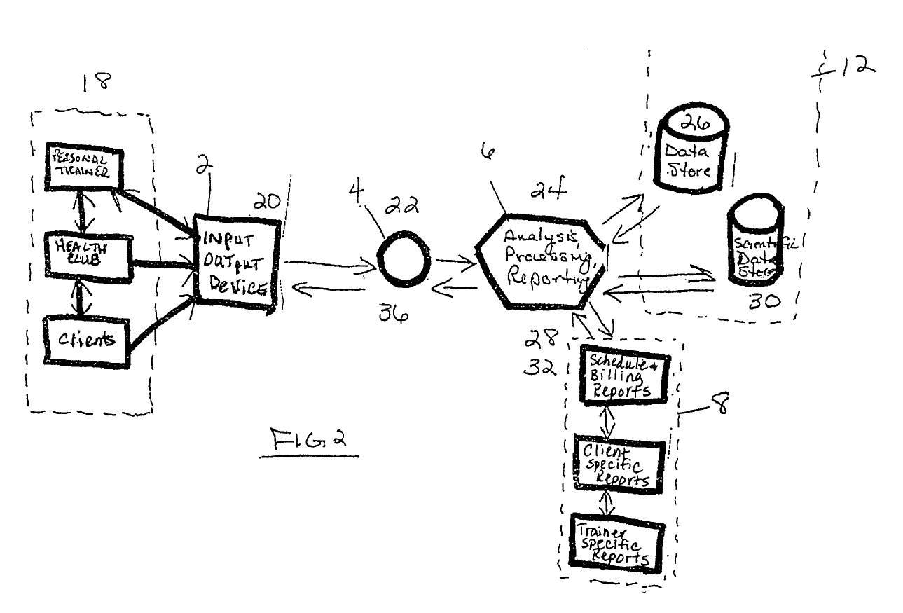

To use the invention, the trainer will attend a training session with a client. As described in FIG. 2, the trainer will record data directly into a hand held computer hardware or record data into a notebook for later transfer into an electronic medium, as in Step 20. When the trainer returns to his or her office, he or she will send the recorded data, step 22, to the host computer for analysis. The recorded data will be stored, Step 24, and analyzed, Step 26. Typical analysis may include but is not limited to comparison of the input data to norm charts and standards, comparison to athletic training statistics indicative of above average performance, comparison to past performance logs, and determination of intensity factors. The recorded data and resulting analysis may be crosschecked against injuries or medical alerts stored in the database, Step 28. Recommendations for future training paths may also be generated, Step 30. The results of any analysis, cross-checks or recommendations, are compiled in report form, Step 32, and are sent back to the trainer via the network and input device, Step 34, for determination of the next steps.

As a result, the personal trainer will be able to produce and display charts and tables of an individual clients goals, progress towards goals and overall status in variety of program areas. The trainer will have access to, for example, nutritional evaluation formulas, such as skin-fold/body fat charts, body mass index charts, and anthropomorphic measurement charts.

Since a preferred embodiment of the invention has been illustrated and described in detail, it will be apparent that various changes will be made in the disclosed embodiment without departing from the scope or spirit of the invention.

What is claimed is:

1. An automated physical training management system comprising:
an input device for transmitting and receiving training information; via
a network for connecting said input device to
a central processing unit for processing, storing, analyzing, reporting and outputting processed training information back to said input device, which also includes storage capability for storing said training information for comparison and analysis with stored scientific and medical information by said central processing unit.

2. A method for scientific physical training management, comprising the steps of:
attending a physical training session;
recording data into an input device for transmission via a network to a central processing unit;
transmitting said recorded data to a central processing unit for analysis;
storing said recorded data until analysis by said central processing unit, as well as general scientific and medical training data;
comparing said recorded data to said general scientific and medical training data; and
transmitting the analyzed and compared data back to said input device.
